(19) United States
(12) Patent Application Publication
(10) Pub. No.: US 2025/0060719 A1
(43) Pub. Date: Feb. 20, 2025

(54) METHOD FOR CONTROLLING THE ENERGY CONSUMPTION OF AN AUTOMATION FIELD DEVICE

(71) Applicant: Endress+Hauser SE+Co. KG, Maulburg (DE)

(72) Inventors: Christian Strittmatter, Rickenbach (DE); Simon Gerwig, Schopfheim (DE); Bernd Dobrunz, Lörrach (DE)

(21) Appl. No.: 18/721,252

(22) PCT Filed: Dec. 1, 2022
(86) PCT No.: PCT/EP2022/084102

§ 371 Date: Jun. 18, 2024

(30) Foreign Application Priority Data
Dec. 22, 2021 (DE) 10 2021 134 390.9

(51) Int. Cl. G05B 19/042

(52) U.S. Cl. CPC G05B 19/0423; G05B 2219/25428; G05B 2219/2639

(57) ABSTRACT

A method for controlling energy consumption of a field device of automation technology, comprises determining a minimum available total power for the field device; dividing the minimum available total power among individual modules of the field device in accordance with maximum allowable power requirements for the modules; determining an actual, current power requirement for at least one module; ascertaining a power difference between the maximum allowable power requirement determined for the at least one module and the actually current power requirement of the at least one module; controlling the at least one control component of the at least one module as a function of the ascertained power difference, so that the power difference is minimized, especially becomes zero and the at least one module utilizes the maximum allowable power requirement for such module.

The invention relates to a method for controlling the energy consumption of a field device of automation technology as well as to a field device of automation technology.

In process automation technology, field devices are often applied, which serve for registering and/or influencing process variables. Serving for registering process variables are sensors, such as, for example, fill level measuring devices, flow measuring devices, pressure- and temperature measuring devices, pH-redox potential measuring devices, conductivity measuring devices, etc., which register the corresponding process variables, fill level, flow, pressure, temperature, pH value, and conductivity. Referred to as field devices are, in principle, all devices, which are applied near to a process and which deliver, or process, process relevant information.

A large number of such field devices are manufactured and sold by the firm, Endress+Hauser.

Currently in a large number of existing automated plants, so-called two conductor field devices are still applied. Such are connected via a two-conductor line, i.e. a line with two separately formed leads, to a superordinated unit, for example, a control unit PLC or control system. The two conductor field devices are formed, in such case, in such a manner that the measured-, or actuating, values are communicated, i.e. transmitted, as main process variable via the two-conductor line, e.g. a two conductor cable, analogy in the form of a 4-20 mA loop current, thus the electrical current signal. In such case, a loop current of the two-conductor line is set to a specific value corresponding to the registered process variable of the field device, and thus the superordinated unit.

For sending all other data, especially the HART protocol has proven itself, in the case of which a frequency signal is superimposed on the analog, electrical current signal of 4-20 mA for data transmission as digital, two conductor signal. In the HART protocol, switching occurs between 1200 Hz and 2400 Hz for data transmission, wherein the low frequency stands for a logical “0” and the higher frequency for a logical “1”. The only slowly varying, analog, electrical current signal remains unaffected by the frequency superpositioning, so that, by means of HART, analog and digital communications are united.

Besides for data transmission, the two-conductor line serves also for supplying electrical power to the two-conductor field device. In such case, the field device, which is connected to the two-conductor line via a connection terminal, is provided with power necessary for operation in the form of a terminal voltage, which lies across the connection terminal, and the loop current, which flows via the connection terminal. Usually, in the case of two-conductor field devices, a supply voltage between 10-35 V is placed across the connection terminals. In this way, in case of a failure current of ≤3.6 mA and a minimum input voltage of e.g. 10 V, a minimum operating power of ≤36 mW is available. This is often critical just for operation of base functionalities.

Thus, a complex power management is necessary, in order that besides operating the base functionalities, such as e.g. the transmitting of measurement- and/or actuating values, other supplemental functionalities are operable, without having the danger that a malfunction, for example, a crash, of an electronic component might occur. Therefore, traditional design technologies for field devices provide that all functions, both the basic functionality as well as also possible supplemental functionalities, must safely function, even when only minimum operating power is available. For this, the field device ascertains at startup the minimum available operating power based on the supply voltage at the connection terminals as well as the failure current (≤3.6 mA). Then, a power budget for each module is ascertained. Such can be done by a computing unit, for example, a microprocessor, of a main electronics of the field device. The power budget ascertained for a module is then reported to the module. The module, in turn, then performs its own power management, such that it comes to know for each function, e.g. the pressing of a key and/or the displaying of information in the case of a display- and/or interaction module, the wireless transmitting of data in the case of a radio module or the performing of an update and/or the transmitting of measurement- and/or actuating values in the case of the main-, or sensor, module, how much energy the one time execution of such a function requires and then so controls the frequency of execution that, in total, no more power is consumed than that available according to the predetermined budget.

Disadvantageous in such procedure is that in the module, or modules, for each function always the energy consumption for the most disadvantageous case (e.g. temperature, component variation, aging of the component, etc.) must be kept available, in order that under no circumstances can a malfunction, for example, in the form of a crash, occur. This leads, however, to the fact that, in most cases, the provided budget is not fully used up, so that, indeed, a malfunction can be prevented, but such is to the detriment of performance.

An object of the invention is, thus, to provide a power management for a field device of automation technology, in the case of which a malfunction based on an undersupply of power is prevented and, nevertheless, maximum possible performance is obtained.

The object is achieved according to the invention by the method as defined in claim 1 and the field device as defined in claim 6.

The method of the invention for controlling energy consumption of a field device of automation technology comprises steps as follows:
determining a minimum available total power for the field device;
dividing the minimum available total power among individual modules of the field device in accordance with maximum allowable power requirements for the modules, wherein the sum of the individual maximum allowable power requirements of the modules does not exceed the minimum available total power;
determining an actual, current power requirement for at least one module, wherein the actually current power requirement comprises the power uptakes of all power receivers with the exception of at least one control component of the at least one module;
ascertaining a power difference between the maximum allowable power requirement determined for the at least one module and the actually current power requirement of the at least one module;
controlling the at least one control component of the at least one module as a function of the ascertained power difference, so that the power difference is minimized, especially becomes zero, and the at least one module utilizes the maximum allowable power requirement for such module.

According to the invention, a method is provided, in the case of which the actually needed power of an electronic module is determined and compared with the power requirement determined as maximum allowable for such module and a power difference is minimized by a control component.

An advantageous form of embodiment of the method of the invention provides that the determining of the actual, current power requirement for the at least one module is performed by determining an electrical current, especially via a shunt resistance present in the module.

Another advantageous form of embodiment of the method of the invention provides that the at least one control component comprises at least one light emitting diode for backlighting a display, especially a TFT display, and is adjusted by controlling an electrical current for the at least one light emitting diode.

Another advantageous form of embodiment of the method of the invention provides that a smoothing, especially an average value formation, is performed for the actually current power requirement and the smoothed, current power requirement is used for ascertaining a power difference.

Another advantageous form of embodiment of the method of the invention provides that the dividing of the minimum available total power among the individual modules of the field device is performed using mapping information.

The invention relates further to a field device of automation technology, which is adapted to perform the method as claimed in one or more of the above described forms of embodiment.

The invention will now be explained in greater detail based on the appended drawing, the figures of which show as follows:

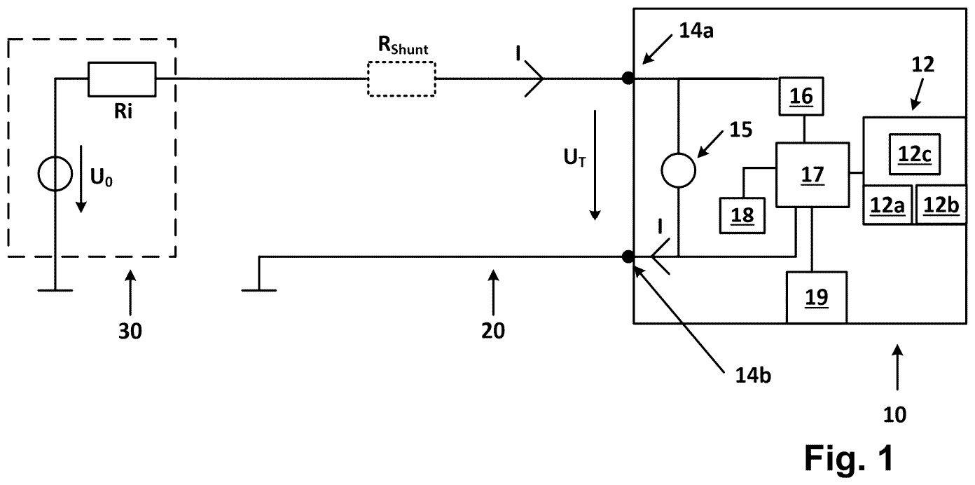

FIG. 1 a system of automation technology, and

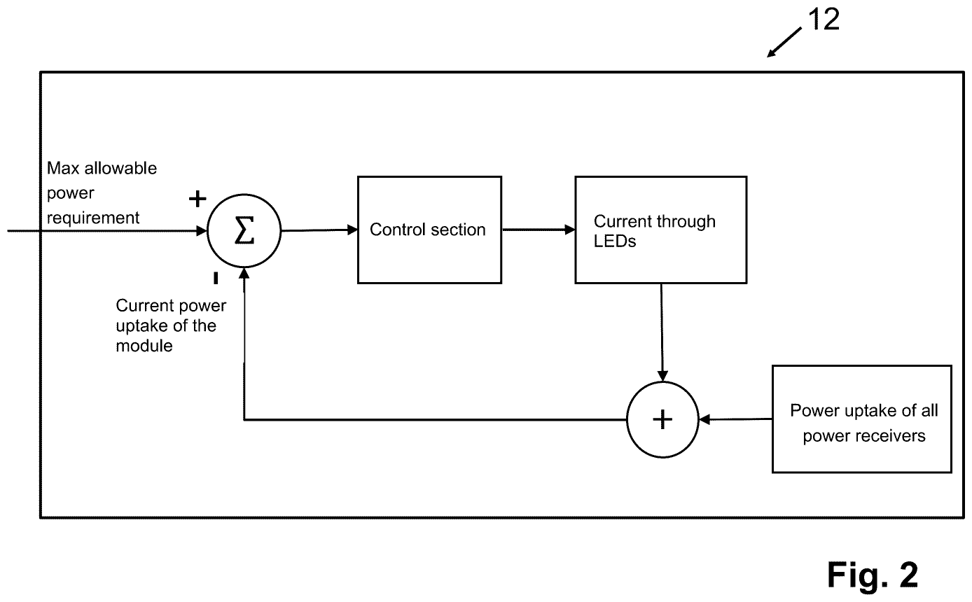

FIG. 2 a control loop, such as implemented according to the invention for a secondary module of a field device.

FIG. 1 shows an automation system comprising a voltage source 30 with an internal resistance Ri, a field device of automation technology 10 and a two-conductor line 20, which connects the voltage source 30 and the field device 10 with one another, as well as, optionally, a shunt resistor Rₛₕᵤₙₜ provided in the two-conductor line 20.

Field device 10 includes a main electronic module with two input terminals 14a, 14b, to which the two-conductor line 20 is connected, an electrical current control unit 15 for setting an electrical current value I, a voltage measuring unit 16 for registering a terminal voltage U_{T} at the input terminal 14, a computing unit 17, for example, a microprocessor, for control and/or evaluation, as well as a sensor module 19 for registering a physical variable.

Via the two-conductor line 12, the input terminals 14a, 14b and, thus, the field device 1 are connected with the voltage source 30 and form a so-called electrical current loop. Voltage source 30 supplies the field device 10 with energy via the two-conductor line 20. For this, the field device 10 is provided with operating power as a function of the terminal voltage U_{T}, which lies across the connection terminals 14a, 14b, and the electrical current I, which flows through the two-conductor line.

Furthermore, the field device includes at least one secondary module 12. The at least one secondary module 12 can be, for example, a display- and/or interaction module, in the following also called a display module, via which information of the field device can be shown and/or by which inputs, for example, for parametering and/or configuring the field device, can be made by an operator. FIG. 1 shows, by way of example, only one secondary module 12. However, the invention is not limited to one secondary module 12, but, instead, can, of course, have other secondary modules. For example, the field device can have another secondary module 12 in the form of a radio module. Furthermore, a secondary module can also be the sensor- and/or actuator module. The display module can be especially a colored TFT display module, which has light means, e.g. LEDs, for backlighting. The invention will now be described based on a TFT display module as a secondary module. Equally, the invention is not limited to a TFT display module as display module.

According to the invention, the method provides steps as follows for controlling the energy consumption of the field device:

In a first step, the minimum total power provided for the field device 10 is determined. Such can occur, for example, in such a manner that the voltage measuring unit 16 measures the terminal voltage U_{T} at a failure current of 3.6 mA, such that the computing unit 17 can ascertain the minimum provided power based on the terminal voltage U_{T} and the electrical current value of 3.6 mA known for signaling a failure.

Then, the minimum provided total power is divided among the one or more secondary modules 12, such that for each secondary module 12 maximum allowable power uptake is known. Such can occur in such a manner that the computing unit is or was provided with a mapping information, for example, in the form of a table, from which the individual maximum allowable power requirements for the secondary modules of the field device 10 can be learned. The mapping information can be stored in the field device 10, for example, in an internal memory element, by the field device manufacturer during production of the field device 10. Alternatively, the mapping information can also be installed by an operator of the field device, e.g. by manual input or by wireless transmission by means of a smartphone. Likewise it can be provided that, in the presence of a plurality of secondary modules, the mapping information is used to establish certain priorities. For example, when a display module and a sensor- and/or actuator module are present as secondary modules, the mapping information can be used to reduce a measuring-, or actuating, rate and to reduce a backlighting of the display module or vice versa. The maximum allowable power consumption can be transmitted to a module. For example, the computing unit 17 can transmit such to another computing unit 12c of the module, for example, an additional microprocessor.

In a step following thereon, which usually occurs during use, e.g. measurement operation, of the field device 10, for example, in an automated plant, the current power requirement for the secondary 12 module is registered. The ascertaining of the current power requirement occurs, in such case, in such a manner that all power receivers, with the exception of a control component 12b of the secondary module, are taken into consideration. For this, the secondary module 12 can have a shunt resistance 12a, via which the total electrical current uptake of the individual power receivers of the secondary module occurs, wherein the electrical current draw of the control component 12b is not registered. In order to prevent a blinking and/or pulsating of the backlighting, it can be provided that a smoothing is performed for the actually current power requirement. This can occur, for example, by an average value formation. By means of the total electrical current uptake, the computing unit 12c integrated in the secondary module 12 can determine the instantaneous total power uptake of the module.

With the total power uptake of the module known, in a next step, a power difference between the (in given cases, smoothed) current power consumption of the module and the maximum allowable power consumption for such module is determined. This can be done by the computing unit 12c of the module.

Then, by a control loop correspondingly implemented in the secondary module 12, such as shown in FIG. 2 by way of example, the control component 12b of the module can be controlled as a function of the earlier ascertained power difference in such a manner that the power difference is minimized. In the best case, the control component 12b is controlled in such a manner that the power difference becomes essentially zero or approaches zero. In this way, the maximum power consumption earlier determined for the module 12 is fully exploited. The control component 12b can, for example, in the case of the TFT display module, comprise the LEDs for backlighting. The secondary module 12 then controls the power difference by sending more or less electrical current through the LEDs for backlighting. In this way, it can be achieved that always the complete budget is used up and at the same time the backlighting is always maximally bright.

### LIST OF REFERENCE CHARACTERS

10 field device of automation technology
12 secondary module, for example, display module, especially TFT display module
12a shunt resistance of the secondary module
12b control component, e.g. LEDs for backlighting, of the secondary module
12c computing unit of the secondary module
14a, 14b input terminals
15 electrical current control unit
16 voltage measuring unit
17 computing unit, for example, microprocessor
18 memory element
19 sensor- and/or actuator module
20 two-conductor line
30 external voltage source, for example, a PLC
Rₛₕᵤₙₜ shunt resistance
Ri internal resistance of the voltage source
I electrical current value, loop current
U_{T} terminal voltage

1-6. (canceled)

7. A method for controlling energy consumption of a field device of automation technology, comprising:
determining a minimum available total power for the field device;
dividing the minimum available total power among individual modules of the field device in accordance with maximum allowable power requirements for the modules, wherein a sum of the individual maximum allowable power requirements of the modules does not exceed the minimum available total power;
determining an actual current power requirement for at least one module of the modules of the field device, wherein the actual current power requirement includes a power uptakes of all power receivers with the exception of at least one control component of the at least one module;
ascertaining a power difference between the maximum allowable power requirement determined for the at least one module and the actually current power requirement of the at least one module; and
controlling at least one control component of the at least one module as a function of the ascertained power difference so that the power difference is minimized and the at least one module utilizes the maximum allowable power requirement for the at least one module.

8. The method as claimed in claim 7, wherein the determining of the actual, current power requirement for the at least one module is performed by determining an electrical current present in the module.

9. The method as claimed in claim 7, wherein the at least one control component comprises at least one light emitting diode for backlighting a display and is adjusted by controlling an electrical current for the at least one light emitting diode.

10. The method as claimed in claim 7, further comprising:
performing a smoothing for the actually current power requirement,
wherein the smoothed, current power requirement is used for ascertaining the power difference.

11. The method as claimed in claim 7, wherein the dividing of the minimum available total power among the individual modules of the field device is performed using mapping information.

12. A field device of automation technology, comprising:
a main electronic module with two input terminals to which a two-conductor line may be connected;
an electrical current control unit for setting an electrical current value;
a voltage measuring unit for registering a terminal voltage at the two input terminals;
a computing unit for control and/or evaluation; and
a sensor module for registering a physical variable,
wherein the computing unit is configured to:
determine a minimum available total power for the field device,
divide the minimum available total power among individual modules of the field device in accordance with maximum allowable power requirements for the modules, wherein a sum of the individual maximum allowable power requirements of the modules does not exceed the minimum available total power,
determine an actual current power requirement for at least one module of the modules of the field device, wherein the actual current power requirement includes a power uptakes of all power receivers with the exception of at least one control component of the at least one module,
ascertain a power difference between the maximum allowable power requirement determined for the at least one module and the actually current power requirement of the at least one module, and
control at least one control component of the at least one module as a function of the ascertained power difference so that the power difference is minimized and the at least one module utilizes the maximum allowable power requirement for the at least one module.
